(19) United States
(12) Patent Application Publication
(10) Pub. No.: US 2006/0049798 A1
(43) Pub. Date: Mar. 9, 2006

(54) Nickel hydrogen battery charger with the function of detection of battery capacity

(76) Inventor: Fu-I Yang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/933,279

(22) Filed: Sep. 3, 2004

(51) Int. Cl. H02J 7/00

(52) U.S. Cl. 320/112

(57) ABSTRACT

A nickel hydrogen battery charger with the function of detection of battery capacity having an instant discharge loop coupled to a charging circuit. A rapid detection of the battery capacity is performed by use of the instant voltage level during discharge. It takes only few seconds to determine if the battery capacity lies within the allowable range. No more charging process is necessary when the batteries reach the preset criterion. To the contrary, a charging process is required when they don't reach it. In this way, it is avoidable that the mixed use of parallel/series-connected batteries with different capacities produces reverse flow, thereby resulting in overheating or even exploding risks due to overdischarge of the batteries with larger capacity.

### BACKGROUND OF THE INVENTION

1. Field of the Invention

The invention relates to a nickel hydrogen battery charger with the function of detection of battery capacity, and more particularly, to an apparatus for determining in few seconds whether the battery capacity is sufficient or not.

2. Description of the Related Art

With the popularization of electronic products like digital cameras, game players, etc., AA/AAA type rechargeable nickel hydrogen batteries are increasingly required. Since their capacity can't be displayed, people tend to mix the fully and not fully charged batteries for use in the electronic products. However, this will cause following drawbacks:
1. The operators don't know when batteries for electronic products are empty. If the batteries are empty and the operators are outdoors, the operators feel disappointed due to the out-of-service of the electronic products like digital cameras.
2. People tend to mix the fully and not fully charged batteries for use in the electronic products. This will easily cause the products out of service during their operation.
3. The mixed use of parallel/series-connected batteries with different capacities produces reverse flow, thereby resulting in overheating or even exploding risks due to overdischarge of the batteries with larger capacity.

Accordingly, the use of the nickel hydrogen secondary batteries still has the aforementioned problems. Besides, the research and development about how to accurately measure the remaining capacity of the nickel hydrogen secondary batteries belongs to a long-term task. There have been some disclosures about how to calculate the battery capacity. For example, the voltage and current values of the batteries are transmitted through multi-loop voltage testers to a computer for drawing curves according to features of the internal resistance. The individual feature of the batteries can be determined by judging the clearance between the feature curves. However, confusion occurs due to the complexity and great amount of the battery feature curves, thereby affecting the reading accuracy. Moreover, the detection process takes a long time (about 50˜60 minutes) so that it is impractical in use. Besides, the aforementioned measuring technique doesn't apply to the nickel hydrogen secondary batteries and their chargers.

Furthermore, the nickel hydrogen battery charger features small volume and convenient carrying. The too complex way and apparatus to measure the battery capacity doesn't meet the market requirement. If the battery capacity detector and the conventional charger remain as individual units and can't be integrated in a body, this will cause an unnecessary cost increase and doesn't meet the economical requirement. In addition, this leads to inconvenience in use.

Therefore, it's the main topic of the invention how to detect the capacity of batteries within the conventional battery chamber without increasing the volume and elements of the original nickel hydrogen secondary battery charger.

### SUMMARY OF THE INVENTION

It is a primary object of the invention to provide a nickel hydrogen battery charger with the function of detection of battery capacity that includes an instant discharge loop coupled to a charging circuit. A rapid detection of the battery capacity is performed by use of the instant voltage level during discharge. It takes only few seconds to determine if the battery capacity lies within the allowable range. No more charging process is necessary when the batteries reach the preset criterion. To the contrary, a charging process is required when they don't reach it. In this way, it is avoidable that the mixed use of parallel/series-connected batteries with different capacities produces reverse flow, thereby resulting in overheating or even exploding risks due to overdischarge of the batteries with larger capacity.

It is another object of the invention to provide a nickel hydrogen battery charger with the function of detection of battery capacity that has a simple and effective configuration with slight cost increase and an ergonomic use. In addition, the decision to charge the batteries can be made by the result created by a judging and displaying unit.

### BRIEF DESCRIPTION OF THE DRAWINGS

The accomplishment of this and other objects of the invention will become apparent from the following descriptions and its accompanying drawings of which:

FIG. 1 is a perspective view of a first embodiment of the invention;

FIG. 2 is a circuit diagram of the first embodiment of FIG. 1;

FIG. 3 is a block diagram of the main structure of the invention;

FIG. 4 is a block diagram of the main structure of the invention, showing that batteries B1˜B4 undergo an instant discharge when the instant discharge loop is in on-state;

FIG. 5 is a perspective view of a second embodiment of the invention;

FIG. 6 is a schematic drawing of the battery capacity detection with the capacity within the applicable range; and

FIG. 7 is a schematic drawing of the battery capacity detection with an insufficient capacity.

### DETAILED DESCRIPTION OF THE PREFERRED EMBODIMENT

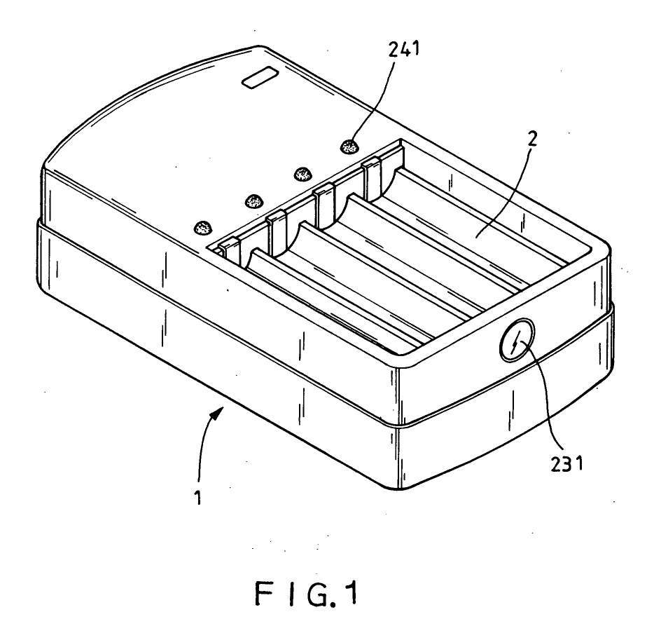

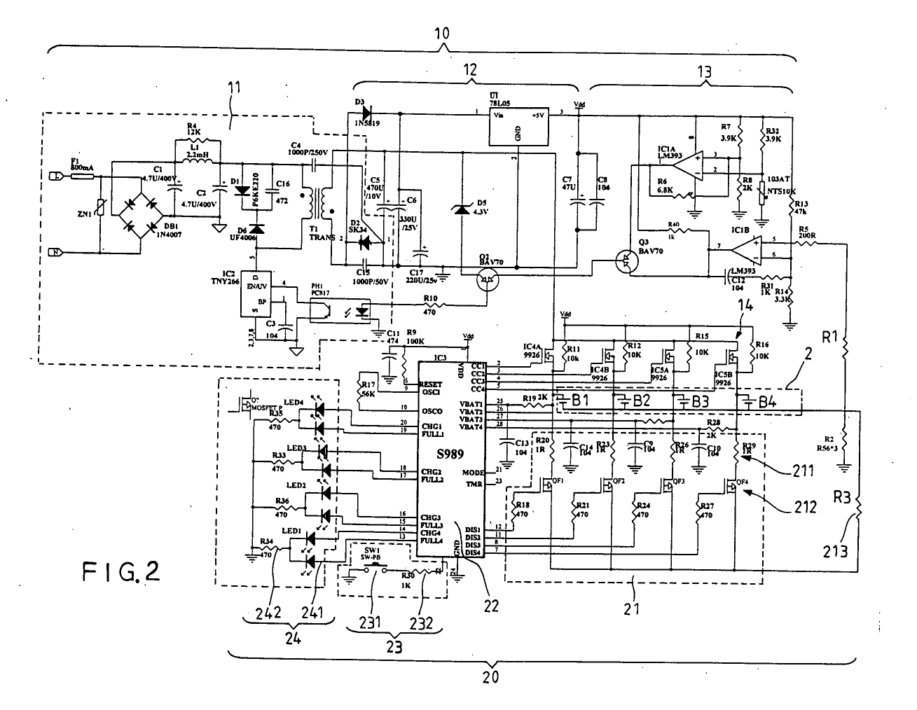

First of all, referring to FIG. 1, a nickel hydrogen battery charger with the function of detection of battery capacity in accordance with the invention is shown. A main body 1 of the charger includes a battery chamber 2 in which at least one nickel cadmium or nickel hydrogen battery is placed for charging process. As shown in FIG. 2, the main body 1 has a charging circuit 10 to charge batteries B1˜B4 in the battery chamber 2 with a charging current 13. A convertible power source 11 provides direct current required by the charging circuit 10 and a reference voltage source 12. The charging principle is not the object of the invention so that no further descriptions thereto are given hereinafter.

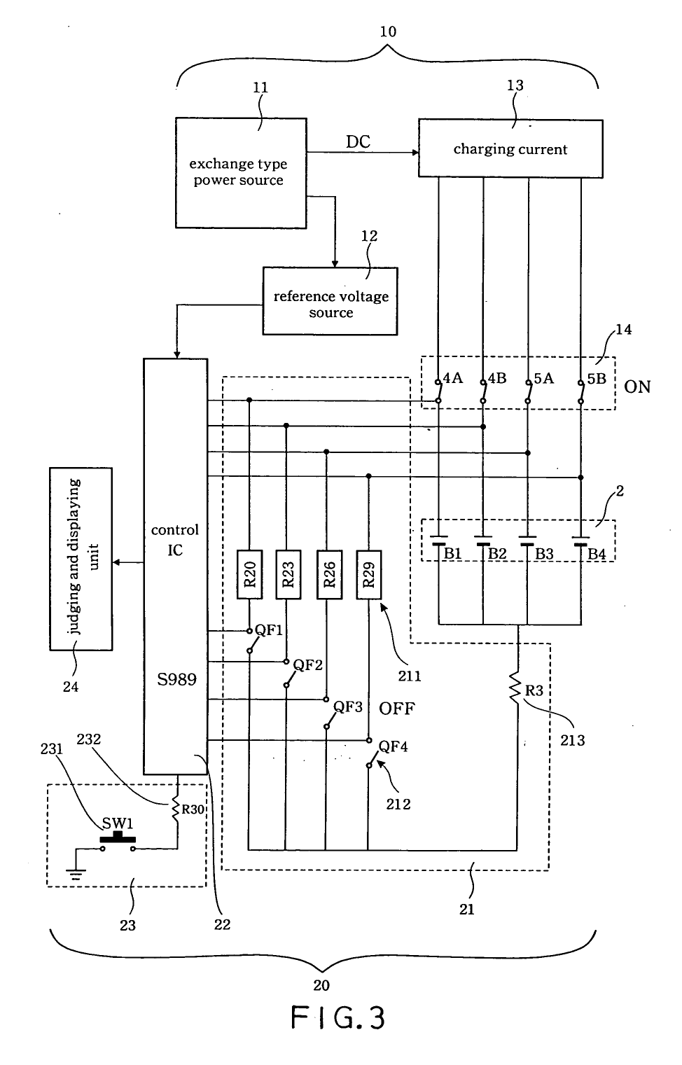

It's apparent from FIGS. 1 through 3 that means 20 for detecting the battery capacity is installed within the main body 1 and includes an instant discharge loop 21, a control integrated circuit (IC) 22, a discharge control unit 23 and a judging and displaying unit 24.

The instant discharge loop 21 is coupled to the charging circuit 10 and includes a plurality of parallel-connected loads 211, discharge switches 212, and a series-connected first resistance 213. The parallel-connected loads 211 can be resistance R20, R23, R26, and R29 while the discharge switches 212 can be metal oxide semiconductor field effect transistor (MOSFET) QF1, QF2, QF3, QF4. The MOSFET, as shown in FIG. 2, belongs to a power type MOSFET. The loads 211 serves as false load for a rapid detection of instant voltage level of individual batteries.

The control IC 22 is coupled to the charging circuit 10 and the instant discharge loop 21 for a comparison between the instant voltage level of each battery detected by the instant discharge loop 21 and the preset reference voltage. The voltage required by the control IC 22 is provided by the reference voltage source 12 in the charging circuit 10.

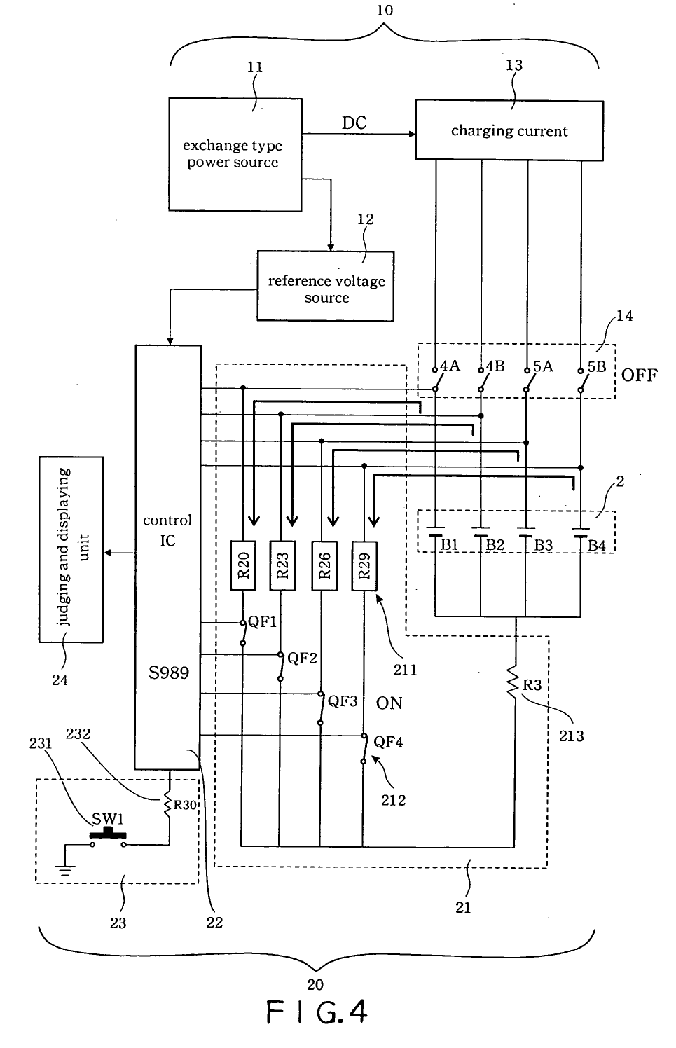

The discharge control unit 23 is extended from the control IC 22 and composed of a press button 231 on the surface of the main body 1 and a second resistance 232. By pressing down the press button 231, the control integrated circuit 22 sends a command to disconnect the charging switches 14 on the charging circuit 10. The charging switches 14 are switches 4A, 4B, 5A, 5B corresponding to circuits B1, B2, B3, B4, respectively. In the ordinary on-state, the batteries B1, B2, B3, B4 are charged by the charging current 13. In pressing down the press button 231, the switches 4A, 4B, 5A, 5B, as shown in FIG. 4, are disconnected in an off-state while the discharge switches 212 QF1, QF2, QF3, QF4 in the instant discharge loop 21 are switched first in an on-state and then disconnected immediately after that. The connection duration is very short in time (about one second) just for the instant discharge of the batteries B1, B2, B3, B4 in the battery chamber 2. Since the discharge time is very short, the consumed energy is very slight. However, the control integrated circuit (IC) 22 can detect the instant voltage level of the batteries B1, B2, B3, B4 for comparing with the preset voltage.

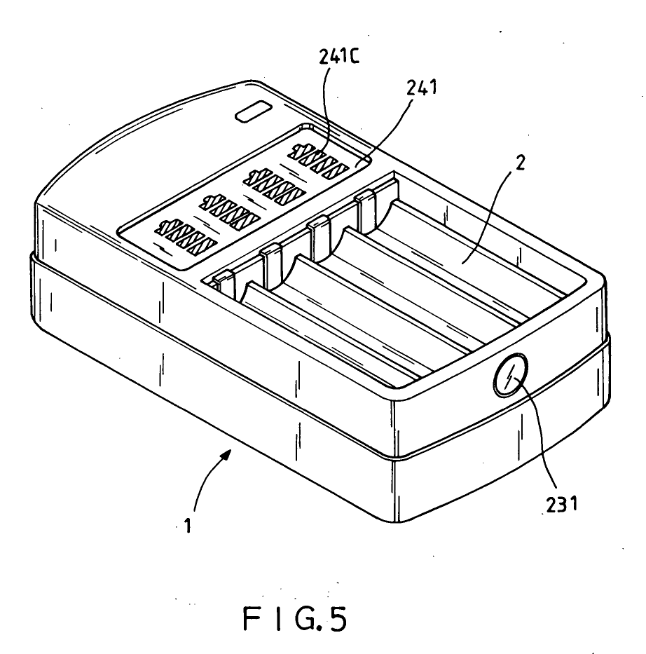

The judging and displaying unit 24 is extended from the control integrated circuit (IC) 22 and composed of several displaying elements 241 on the surface of the main body 1 and corresponding resistances 242. The displaying elements 241 in accordance with the applicable embodiment are two different-colored light emitting diodes (LED) for each battery. For example, if green is designed for the light emitting diode 241a, red will be for another light emitting diode 241b. Alternatively, the displaying element 241 can be a double-colored light emitting diode for each battery. Besides, as shown in FIG. 5, the displaying element 241 can be designed to be liquid crystal display (LCD) 241c for displaying the battery capacity with numbers or patterns. In this way, the operators can easily know if the batteries have been fully charged. The aforementioned battery chamber 2 is designed in a parallel connection. Alternatively, a series-connected battery chamber 2 is also possible.

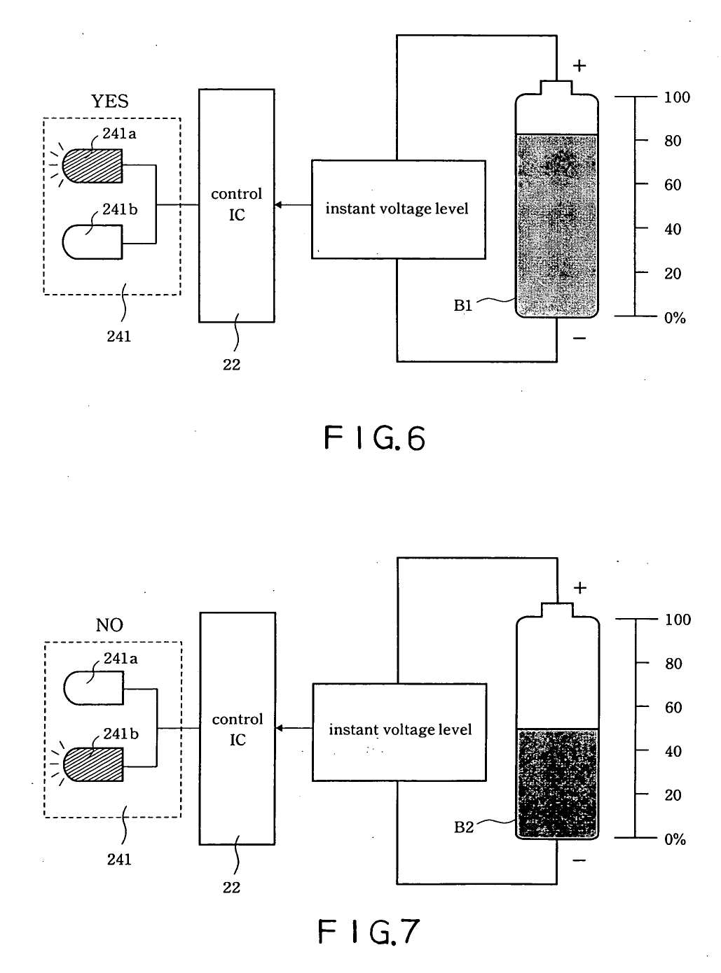

After comparing the instant discharge voltage level of each battery B1, B2, B3, B4 with the corresponding preset reference voltage, the control integrated circuit (IC) 22 will determine if the capacity lies within the applicable range. As shown in FIG. 6, when the capacity of the battery B1 amounts to more than a preset value like 80%, it will be detected by the control integrated circuit (IC) 22 through the instant discharge voltage level. Meanwhile, the signal about the battery capacity will be transmitted to the judging and displaying unit 24. In this case, the green LED 241a lights up to show that the battery B1 still has sufficient capacity and further charging process is not necessary. To the contrary, as shown in FIG. 7, when the capacity of the battery B2 lies under 80%, the control integrated circuit (IC) 22 enables the red LED of the displaying element 241 to light up. In this way, the operator can readily realize the insufficient capacity of the battery B2 and the battery B2 should remain in the battery chamber 2 for further charging process. This will ensure that the capacity of batteries keeps over the preset value 80% and the use of the connected apparatus with the batteries can be prolonged. Moreover, it is avoidable that the mixed use of parallel/series-connected batteries with different capacities produces reverse flow, thereby resulting in overheating or even exploding risks due to overdischarge of the batteries with larger capacity. Therefore, the invention ensures a convenient test and enhances the safety in use.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A nickel hydrogen battery charger with the function of detection of battery capacity comprising:
a) a main body having a battery chamber for receiving a plurality of batteries, a charging circuit being disposed within the battery chamber to charge batteries with a charging current, a plurality of charging switches being installed in the charging circuit;
b) means for detecting the battery capacity disposed within the main body, including:
i) an instant discharge loop coupled to the charging circuit for detecting the instant voltage level of each battery within the battery chamber when the charging switches are disconnected in off-state and the instant discharge loop is brought in closed state;
ii) a control integrated circuit (IC) coupled to the charging circuit and the instant discharge loop for a comparison between the instant voltage level of each battery detected by the instant discharge loop and the preset reference voltage;
iii) a discharge control unit extended from the control IC, the discharge control unit having a press button on the surface of the main body, wherein, by pressing down the press button, the control IC sends a command to disconnect the charging switches in off-state while the instant discharge loop is made in on-state and immediately thereafter in off-state; and
iv) a judging and displaying unit extended from the control IC, the judging and displaying unit having at least one displaying element on the surface of the main body, wherein, after the control IC undergoes the comparison between the instant voltage level of each battery and the preset reference voltage, the result is displayed on the displaying element for the operator to determine if the capacity of the batteries is sufficient.

2. The nickel hydrogen battery charger with the function of detection of battery capacity as recited in claim 1 wherein the instant discharge loop includes a plurality of parallel-connected loads, discharge switches, and a series-connected first resistance.

3. The nickel hydrogen battery charger with the function of detection of battery capacity as recited in claim 2 wherein the loads are constructed as resistances while the discharge switches are metal oxide semiconductor field effect transistor (MOSFET).

4. The nickel hydrogen battery charger with the function of detection of battery capacity as recited in claim 1 wherein a second resistance is interposed between the press button of the charging circuit and the control IC.

5. The nickel hydrogen battery charger with the function of detection of battery capacity as recited in claim 1 wherein the displaying element of the judging and displaying unit is light-emitting diode (LED).

6. The nickel hydrogen battery charger with the function of detection of battery capacity as recited in claim 1 wherein the displaying element of the judging and displaying unit is liquid crystal display (LCD).
